(19) United States
(12) Patent Application Publication
(10) Pub. No.: US 2014/0110620 A1
(43) Pub. Date: Apr. 24, 2014

(54) SPLIT AND BRAZED POWDERED METAL VALVE BODY

(71) Applicant: GM GLOBAL TECHNOLOGY OPERATIONS LLC, Detroit, MI (US)

(72) Inventor: Robert Alan Dziurda, Waterford, MI (US)

(73) Assignee: GM Global Technology Operations LLC, Detroit, MI (US)

(21) Appl. No.: 13/655,944

(22) Filed: Oct. 19, 2012

(51) Int. Cl. F16K 27/00; B23K 31/02

(52) U.S. Cl. 251/367; 228/164

(57) ABSTRACT

A valve body assembly for use in an automotive transmission is provided. The valve body assembly includes a first valve body part formed of powdered metal and a second valve body part formed of powdered metal. The first valve body part is attached to the second valve body part by a brazed joint. A method of forming a valve body assembly is also provided. The method includes forming a first valve body part from powdered metal, forming a second valve body part from powdered metal, and sinter brazing the first and second valve body parts together to form a brazed joint between the first and second valve body parts.

### FIELD

The present disclosure relates to a part for use in an automotive transmission, and more particularly, to a valve body for controlling the flow of automatic transmission fluid within various parts of the transmission.

### BACKGROUND

The statements in this section merely provide background information related to the present disclosure and may or may not constitute prior art.

In automatic transmissions, hydraulic fluid is used to actuate clutches and/or brakes in order to select or maintain gear ratios. Valves supply hydraulic fluid pressure to the clutches and/or brakes. A valve body may have several valves to supply the hydraulic fluid pressure to the clutches and/or brakes. For example, the valve body has a plurality of passages that direct transmission fluid to valves to shift the transmission as desired.

Typically, machining operations are used to create the passages within the valve body. Such machining is expensive and results in metal chip debris, which may become stuck in the valve body passages or may otherwise undesirably remain in or on the valve body. In addition, manufacturers strive to reduce the mass and weight of nearly all automotive components. Accordingly, new and improved valve bodies are sought.

### SUMMARY

In one variation, which may be combined with or separate from the other variations described herein, a valve body assembly for use in automotive transmission is provided. The valve body assembly includes a first valve body part formed of powdered metal and a second valve body part formed of powdered metal. The first valve body part is attached to the second valve body part by a brazed joint.

In another variation, which may be combined with or separate from the other variations described herein, a valve body assembly for use in an automotive transmission is provided. The valve body assembly includes a first valve body part formed of an aluminum powdered metal and a second valve body part formed of an aluminum powdered metal. The first valve body part is directly attached to the second valve body part by a brazed joint that is formed by sinter brazing. The brazed joint is formed from foil, a stamped insert, and/or paste. The first and second valve body parts form a main web of the valve body assembly, and the brazed joint is disposed substantially through the center of the main web. The valve body assembly has a plurality of channels formed therethrough for directing transmission fluid.

In another variation, which may be combined with or separate from the other variations described herein, a method of forming a valve body assembly is provided. The method includes forming a first valve body part from powdered metal and forming a second valve body part from powdered metal. The method also includes sinter brazing the first and second valve body parts together to form a brazed joint between the first and second valve body parts.

Further aspects and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a pre-assembly perspective view of a valve body assembly, in accordance with the principles of the present disclosure;

FIG. 2 is a perspective view of the valve body assembly of FIG. 1, after the valve body has been assembled, according to the principles of the present disclosure;

FIG. 3 is a perspective view of another assembled valve body assembly, according to the principles of the present disclosure; and

FIG. 4 is a block diagram illustrating a method of forming a valve body assembly, in accordance with the principles of the present disclosure.

### DETAILED DESCRIPTION

The following description is merely exemplary in nature and is not intended to limit the present disclosure, application, or uses.

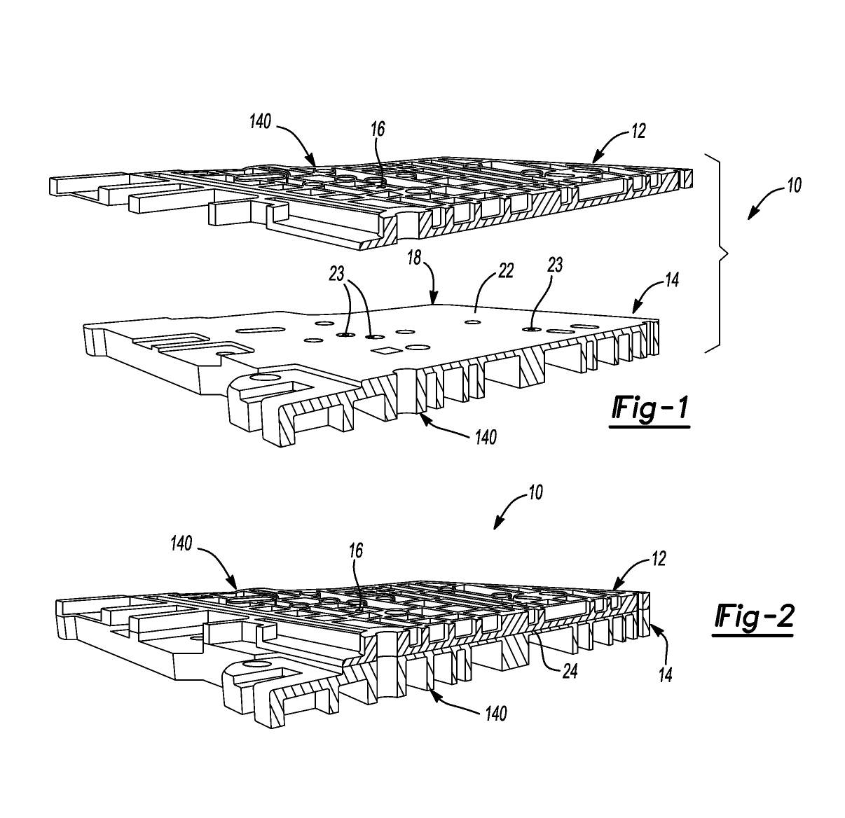

With reference to FIG. 1, two halves or parts 12, 14 of a valve body assembly 10 prior to assembly are illustrated. The valve body assembly 10 has a plurality of passages 16 formed therein, which are used to direct hydraulic fluid to the clutches and/or brakes of the transmission (not shown). Thus, the first part 12 is a portion of the valve body assembly 10, and the second part 14 is another portion of the valve body assembly 10.

The first part 12 and the second part 14 are formed of a powdered metal, such as aluminum. The passages 16 may be formed within the powdered metal valve body 10 without the use of machining, and tighter tolerances may be used than would otherwise be used in a machining operation. A brazing material 18 is applied or added to the inner surface 20 of the first part 12 and/or to the inner surface 22 of the second part 14. The first and second parts 12, 14 are then brazed, and preferably, sinter brazed. The first and second parts 12, 14 also have a plurality of through-holes 23, which must not leak with respect to each other. Therefore, the brazing of the two parts 12, 14 together needs to result in excellent sealability.

Referring now to FIG. 2, the valve body assembly 10 is illustrated as assembled, after the first and second parts 12, 14 have been brazed or sinter brazed, forming a brazed joint 24 between the first and second parts 12, 14. Thus, the first and second parts 12, 14 are attached together by the brazed joint 24. In the illustrated embodiment, the first and second parts 12, 14 are directly attached to each other by the brazed joint 24. When the first and second parts 12, 14 are attached together, they form the substantial entirety of the valve body assembly 10. The brazed joint 24 may be located substantially centrally within the valve body assembly 10, or the brazed joint 24 may be located off-center, as illustrated in FIG. 2.

When assembled, the first valve body part 12 and the second valve body part 14 form a main web of the valve body assembly 10. The valve body assembly 10 is split down the center the main web, into the first and second parts 12, 14, before being assembled. The first and second parts may each have a web thickness of about 1.5 mm, by way of example.

The brazing material 18 that ultimately forms the brazed joint 24 may be any suitable material. For example, the brazing material 18 and the brazed joint 24 may be formed from one or more of foil, a stamped insert, and paste. The brazing material 18 may provide sealability and mechanical strength to hold the first and second parts 12, 14 together.

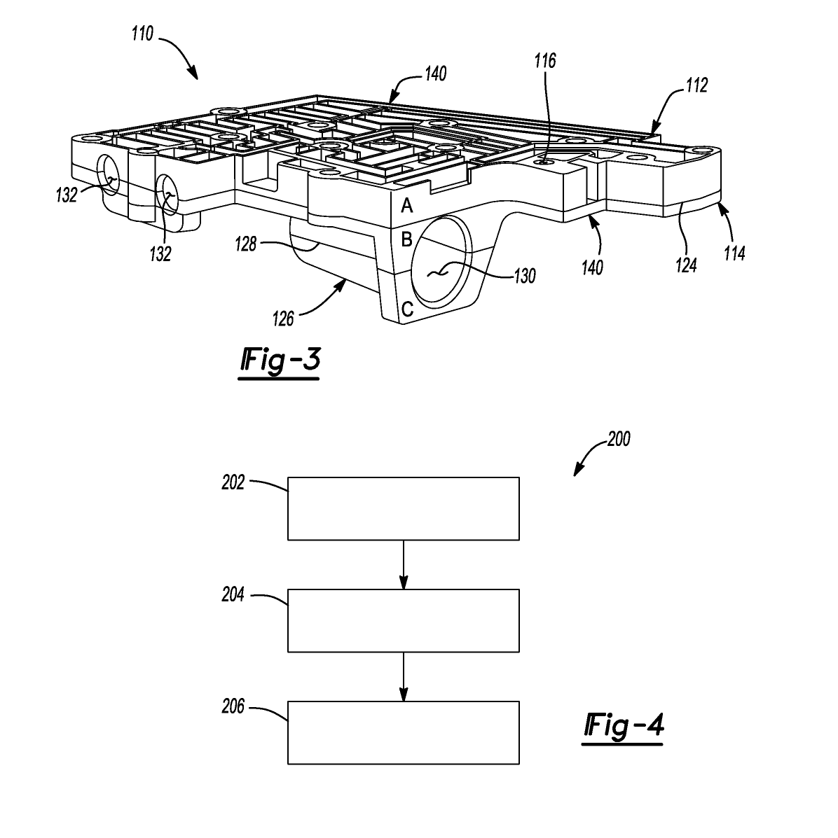

Referring now to FIG. 3, another valve body assembly is illustrated and generally designated at 110. Like the valve body assembly 10 described above, the valve body assembly 110 in FIG. 3 has a first valve body part 112 and a second valve body part 114. The second valve body part 114 is directly attached to the first valve body part 112 by a brazed join 124, wherein the first and second parts 112, 114 were preferably sinter brazed together. The rest of the description of the valve body assembly 10 above applies equally to the valve body assembly 110, and it is incorporated by reference herein. For example, one or both parts 112, 114 have a plurality of passageways 116 formed therein for directing hydraulic transmission fluid.

In addition to the first and second valve body parts 112, 114, the valve body assembly 110 has a third valve body part 126 that is sinter brazed to the second valve body assembly 114 to form a second brazed joint 128 between the second and third valve body parts 114, 126.

The valve body assembly 110 has portions forming a bore 130 through the valve body assembly 110. In the illustrated embodiment, the second part 114 forms a first half of the bore 130 and the third part 126 has portions forming the other half of the bore 130. Thus, the valve body assembly 110 is split down the centerline of the bore 130, into the second and third parts 114, 126, before being assembled. In addition, other bores 132 are formed in the valve body assembly 110, which are formed in the first and second parts 112, 114. In the illustrated embodiment, the first part 112 forms first halves of the bores 132 and the second part 114 forms second halves of the bores 132. The valve body assembly 110 is split down the centerline of the bores 132, into the first and second parts 112, 114, before being assembled.

After the valve body parts 112, 114, 126 are attached together, sizing pins are placed in the bores 130, 132 and the valve body assembly 110 is placed in a sizing press to accurately size the bores 130, 132, which require very tight tolerances. In addition, a sizing press may be used to net form either of the valve body assemblies 10, 110 to flatten the sealing surfaces 140 of the valve body assemblies 10, 110.

Referring now to FIG. 4, a method of forming a valve body assembly 10, 110 is illustrated and generally designated at 200. The method 200 includes a step 202 of forming a first valve body part 12, 112 from powdered metal and a step 204 of forming a second valve body part 14, 114 from powdered metal. Of course, these steps 202, 204 may be performed simultaneously, if desired. The steps 202, 204 of forming the first and second valve body parts 12, 112, 14, 114 may include forming a plurality of channels 16, 116 in the first and second valve body parts 12, 112, 14, 114 for directing transmission fluid through the valve body assembly 10, 110. The powdered metal is preferably provided as aluminum.

The method 200 then includes a step 206 of sinter brazing the first and second valve body parts 12, 112, 14, 114 together to form a brazed joint 24, 124 between the first and second valve body parts 12, 112, 14, 114. The step 206 of sinter brazing the first and second valve body parts 12, 112, 14, 114 together may include directly attaching the first and second valve body parts 12, 112, 14, 114 together with at least one of foil, a stamped insert, and paste.

In some variations, the step 202 of forming the first valve body part 12, 112 may include forming a first half of a bore 130, 132 through the first valve body part 12, 112, and the step 204 of forming the second valve body part 14, 114 may include forming a second half of the bore 130, 132 through the second valve body part 14, 114. The method 200 may also include a step of inserting dowel pins into the bores 130, 132 and pressing the valve body assembly 110 in a sizing press to size the bore(s) 130, 132. In addition, the method 200 may include pressing the sealing surfaces 140 of the valve body assembly 10, 110 in a sizing press to flatten the sealing surfaces 140.

In some variations, the method 200 could further include steps of forming a third valve body part 126 from powdered metal, such as aluminum, and sinter brazing the second and third valve body parts 114, 126 together to form a second brazed joint 124 between the second and third valve body parts 114, 126.

The valve body assemblies 10, 110 described herein may not require machining of the passageways 16, 116 and therefore, the expense of machining and the debris chips therefrom may be reduced or eliminated. In addition, the powdered metal construction of the valve body parts 12, 14, 112, 114, 126 may allow for tighter tolerances of the passageways 16, 116, and therefore, the valve body assemblies 10, 110 may be manufactured smaller and lighter than conventional valve bodies.

The description of the invention is merely exemplary in nature and variations that do not depart from the gist of the invention are intended to be within the scope of the invention. Such variations are not to be regarded as a departure from the spirit and scope of the invention. The features described with respect to a single figure may be applied to other figures herein, without departing from the spirit and scope of the present disclosure.

1. A valve body assembly for use in automotive transmission, the valve body assembly comprising:
a first valve body part formed of powdered metal; and
a second valve body part formed of powdered metal, the first valve body part being attached to the second valve body part by a brazed joint.

2. The valve body assembly of claim 1, wherein the valve body part assembly is formed by sinter brazing.

3. The valve body assembly of claim 2, wherein the first valve body part is directly attached to the second valve body part by the brazed joint.

4. The valve body assembly of claim 3, wherein the first valve body part is a first portion of a valve body and the second valve body part is a second portion of the valve body, the first and second valve body parts being attached together to form the substantial entirety of the valve body.

5. The valve body assembly of claim 4, wherein the first valve body part and the second valve body part form a main web of the valve body.

6. The valve body assembly of claim 5, wherein the valve body has a plurality of channels formed therethrough for directing transmission fluid.

7. The valve body assembly of claim 6, wherein the powdered metal is aluminum.

8. The valve body assembly of claim 2, wherein the brazed joint is formed from at least one of foil, a stamped insert, and paste.

9. The valve body assembly of claim 7, wherein the valve body has portions forming a bore through the valve body.

10. The valve body assembly of claim 9, wherein the first valve body part has portions forming a first half of the bore and the second valve body part has portions forming a second half of the bore.

11. The valve body assembly of claim 10, wherein the brazed joint is a first brazed joint, the valve body assembly further comprising a third valve body part, the third valve body part being attached to the second valve body part by a second brazed joint.

12. A valve body assembly for use in an automotive transmission, the valve body assembly comprising:
a first valve body part formed of an aluminum powdered metal; and
a second valve body part formed of an aluminum powdered metal, the first valve body part being directly attached to the second valve body part by a brazed joint that is formed by sinter brazing, the brazed joint being formed from at least one of foil, a stamped insert, and paste, the first and second valve body parts forming a main web of the valve body assembly, the valve body assembly having a plurality of channels formed therethrough for directing transmission fluid.

13. The valve body assembly of claim 12, wherein the first valve body part has portions forming a first half of a bore through the valve body assembly, the second valve body part having portions forming a second half of the bore, the brazed joint being a first brazed joint, the valve body assembly further comprising a third valve body part, the third valve body part being attached to the second valve body part by a second brazed joint.

14. A method of forming a valve body assembly, the method comprising:
forming a first valve body part from powdered metal;
forming a second valve body part from powdered metal; and
sinter brazing the first and second valve body parts together to form a brazed joint between the first and second valve body parts.

15. The method of claim 14, wherein the step of sinter brazing the first and second valve body parts together includes directly attaching the first and second valve body parts together with at least one of foil, a stamped insert, and paste.

16. The method of claim 14, wherein the steps of forming the first and second valve body parts include forming a plurality of channels in at least one of the first and second valve body parts for directing transmission fluid, and wherein the powdered metal is provided as aluminum.

17. The method of claim 16, wherein the brazed joint is a first brazed joint, the method further comprising:
forming a third valve body part from aluminum powdered metal; and
sinter brazing the second and third valve body parts together to form a second brazed joint between the second and third valve body parts.

18. The method of claim 16, wherein the step of forming the first valve body part includes forming a first half of a bore through the first valve body part, and the step of forming the second valve body part includes forming a second half of the bore through the second valve body part.

19. The method of claim 17, wherein the step of forming the second valve body part includes forming a first half of a bore through the second valve body part, and the step of forming the third valve body part includes forming a second half of the bore through the third valve body part.

20. The method of claim 19, further comprising inserting a dowel pin into the bore and pressing the valve body assembly in a sizing press to size the bore.
